(19) United States
(12) Patent Application Publication
(10) Pub. No.: US 2018/0187045 A1
(43) Pub. Date: Jul. 5, 2018

(54) METHOD FOR COATING WHEEL RIMS, AND RESULTANT DIRT-REPELLENT AND BRAKE DUST-RESISTANT COATINGS

(71) Applicant: BASF Coatings GmbH, Muenster (DE)

(72) Inventors: Mareike MATHIEU, Haltern (DE); Andreas FEIGL, Drensteinfurt (DE); Matthijs GROENEWOLT, Muenster (DE); Marlen LAERBUSCH, Duelmen (DE); Hans-Peter STEINER, Sendenhorst (DE); Wilfried STUEBBE, Greven (DE)

(73) Assignee: BASF Coatings GmbH, Muenster (DE)

(21) Appl. No.: 15/736,611

(22) PCT Filed: Jun. 2, 2016
(86) PCT No.: PCT/EP2016/062513

§ 371 Date: Dec. 14, 2017

(30) Foreign Application Priority Data
Jun. 15, 2015 (EP) 15172105.7

(51) Int. Cl. C09D 175/06; C09D 5/16; C09D 5/08; C08G 18/62; C08G 18/73; C08G 18/18; C08G 18/22; C08G 18/16

(52) U.S. Cl. CPC C09D 175/06; C09D 5/1662; C09D 5/08; C08G 18/6229; C08G 2150/90; C08G 18/1883; C08G 18/227; C08G 18/163; C08G 18/73

(57) ABSTRACT

The present invention relates to a method for producing coatings on metal surfaces, wherein an optionally precoated metal surface has applied to it a coating material composition (K) which comprises
a) at least one polyhydroxyl group-containing component (A),
b) at least one component (B) having on average at least one free and/or blocked isocyanate group and having on average at least one hydrolyzable silane group of the formula (I)

—N(X—SiR″x(OR′)3-x)n(X′—SiR″y(OR′)3-y)m (I)
c) and at least one phosphorus-containing catalyst (D) for the crosslinking of silane groups,
   which comprises
   i. applying the coating material composition (K) to wheel rims,
   ii. 5 to 50 mol % of the isocyanate groups originally present in component (B) having undergone reaction to form silane groups of the formula (I), and
   iii. the phosphorus-containing catalyst (D) being selected from the group of phosphorus-containing acids and/or the partial esters of phosphorus-containing acids.

The present invention further provides the coatings obtainable by this method and also the use thereof.

The present invention relates to a method for coating metal surfaces, wherein at least part of a metal surface has applied to it a coating material composition (K) which comprises at least one polyhydroxyl group-containing component (A), at least one component (B) having on average at least one free and/or blocked isocyanate group and having on average at least one hydrolyzable silane group, and at least one phosphorus-containing catalyst (D) for the crosslinking of silane groups.

The present invention further provides the coatings obtainable by this method and the use thereof.

### PRIOR ART

The use of aluminum rims in automobile construction is greatly increasing, since the aluminum rims, which are substantially lighter in comparison to steel rims, allow fuel savings. In particular, however, the aluminum rims are used for visual reasons, since they give the vehicle a high-value and refined appearance.

A considerable drawback of the aluminum rims, however, is their insufficient corrosion resistance, their soiling since scratches are much more noticeable on the gleaming surface of aluminum than on steel surfaces. The aluminum rims are therefore customarily provided with a coating consisting of a pretreatment, a primer, a basecoat, and a clearcoat. In spite of this coating system, however, aluminum rims exhibit inadequate corrosion resistance, as a result, for example, of the use of gritting salt in the winter, and in particular as a result of the brake dust, which firstly strikes the rim at elevated temperature and secondly then remains very largely on the rim, particularly since cleaning—depending on the rim geometry—is difficult and does not occur fully in a carwash. Even cleaning by hand is difficult owing to the geometry, which is frequently very complex. In addition, both the composition of the brake dust and the extreme conditions under which the brake dust strikes the rim surface make cleaning more difficult, since the brake dust is frequently resistant to the usual cleaning products such as water, soap, and lipophilic substances. Lastly, the soiled rim is also subject to UV exposure, when the vehicle is standing in the sun, for example. Over the course of time, as a result, the brake dust eats right into the coating.

Also increasingly widespread are so-called polished or bright-machined aluminum rims, whose surface consists of a visually high-grade, glossy surface of pure aluminum, provided merely with one or more thin clearcoats which, moreover, are intended not to be visible to the human eye. Here, the protection of the sensitive surface by the only thin clearcoats causes even greater problems.

Accordingly, various coating material compositions for the coating of wheel rims have been developed, especially on the basis of superhydrophobic coatings, for the purpose of eliminating these problems as far as possible, though they have hitherto failed to do so satisfactorily.

Thus, for example, EP-B-1 727 871 describes self-cleaning coatings for wheel rims that optionally first comprise a scratch-resistant perhydropolysilazane basecoat and also comprise, as the upper protective layer essential to the invention, a coating comprising at least one perhydropolysilazane and photocatalytic titanium dioxide.

DE 199 39 199 A1 describes coating materials for wheel rims that comprise as an essential constituent finely divided, electrically conducting particulate solids, preferably particles of barium sulfate with a covering of tin dioxide doped with antimony trioxide.

The intention of this is to prevent electrostatic charging of the coating films, since as a result of such charging the abraded particles of the brake linings that form during braking are attracted by the coating film, adhere to it, and, as a result of the heating of the coating films during braking, are baked into these films.

DE 10 2009 008 868 A1 describes what are called touch protection coatings based on sol-gel networks, which are used for the coating of motor-vehicle trim components, but are said also to be suitable for use for rims.

The U.S. patent U.S. Pat. No. 4,911,954, moreover, discloses a method for the coating of aluminum rims in which first of all a first coating composition is applied that is based on transparent nanoparticles and on a resin which in the cured state has an elongation at break of at least 30% at 20° C. and a low glass transition temperature of −25° C. to +60° C., this coating then having applied to it a second coating composition which in the cured state has a glass transition temperature of +60° C. to +130° C. and an elongation at break of 3% to 30% at 20° C.

The U.S. application US-A-2012/0302693 describes self-cleaning coatings that are based on fluorine-containing graft copolymers and that can likewise be used for coatings in the sector of the automobile industry.

WO05/014742 describes liquid-repellent coatings which are obtained by application of a cationically curable coating material based on a condensation product of a silane with a fluorine-containing silane, and which can be used for a multiplicity of very different applications, such as coatings of buildings and automobiles, coatings in the medical sector, and the like.

The U.S. patent U.S. Pat. No. 7,455,912 describes self-cleaning coatings which are obtained by application of aqueous coating materials based on polymers containing silanol groups, more particularly polyacrylates containing silanol groups. These coating materials are used for example for the rim coating of motor vehicles.

Moreover, EP-B-2 340 286 discloses coating material compositions for the coating of wheel rims, said coatings comprising as a first component the isocyanate group-free reaction product of a diisocyanate with an aminosilane and with a polydimethylsiloxanediol or with a polyethylene glycol, and also, as a second component, the condensation product of a silane.

A disadvantage with all of the known systems is the lack of durability of the coating. Also in need of improvement are the yellowing of the coatings and also the great effort involved in cleaning after exposure.

Another way of coating wheel rims, especially those made from alloy, is to apply first of all a wet primer coating material that compensates the unevennesses, to coat this primer with an electroplatable layer by the PVD process (PVD=Plasma Vapor Deposition), and lastly to chrome-plate the electroplatable layer, as described in DE 102 42 555 A1, for example.

Furthermore, WO 08/74491, WO 08/74490, WO 08/74489, and WO09/077181 disclose coating materials which as well as a polyhydroxyl group-containing component (A) comprise at least one component (B) which contains isocyanate groups and silane groups and which is based on known isocyanates, preferably on the biuret dimers and isocyanurate trimers of diisocyanates, more particularly of hexamethylene diisocyanate. These coating material compositions have the advantage over conventional polyurethane coating materials of a significantly improved scratch resistance in conjunction with good weathering resistance. These coating materials are used in the sector of automobile finishing, although the coating of wheel rims is not described. Desirable in the present context, however, is an improvement in the brake dust resistance of the clearcoat surfaces.

Moreover, EP-B-2 445 948 discloses coating materials which lead to coatings having high scratch resistance in conjunction with good stone chip protection properties and which as well as hydroxyl group-containing poly(meth)acrylates (A) having a glass transition temperature of less than 10° C. further comprise silanized polyisocyanates (B). The coating materials are used especially in the sector of automotive OEM finishing and automotive refinishing, although the coating of wheel rims is not described. Here again, the improvement of the clearcoat surfaces in terms of brake dust resistance is desirable.

Lastly, the as yet unpublished European patent application with the application number EP14151310.1 discloses substrates with a metalized surface and a transparent coating disposed thereon, in which the two-component polyurethane coating material composition used for producing the topmost coat comprises one or more constituents having hydrolyzable silane groups. As a catalyst, these coating material compositions comprise amine-blocked partial esters of phosphoric acid, optionally in combination with an additional amine catalyst. The metalization is accomplished preferably by the PVD or CVD process. These substrates can be used, for example, to produce machine components and machine accessories, motor vehicle components and motor vehicle accessories, especially in the exterior automotive sector, such as for trim strips, for example, and also as mirrors and reflectors, particularly of lamps and headlamps. Here again, however, the coating of wheel rims is not described.

### Problem

The problem addressed by the present invention was therefore that of eliminating the drawbacks and disadvantages described above in the prior art. The intention, accordingly, was to provide a method for coating metal surfaces that leads to coated surfaces having a significantly improved brake dust resistance. The resulting coatings ought therefore to display improved resistances in a laboratory test to simulate the soiling conditions during the braking procedure of a motor vehicle. In this laboratory test, brake dust composition is preheated and applied to a hot metal test panel. The soiled panel is then subjected to accelerated weathering for 200 hours, before being cleaned in a defined way and assessed for its damage scenario. This test is repeated a number of times until there is unacceptable damage to the coating surface. The greater the number of cycles achieved, the better the brake dust resistance.

In addition, the resulting coated metal surfaces are intended as far as possible to be dirt-repellent and easy to clean and also to exhibit a high gloss, a good scratch resistance, and surface hardness. Furthermore, the coated surfaces ought to fulfill the requirements customarily imposed in the automotive finishing sector and also, in particular, in the wheel rim coating sector, such as high color fastness on thermal curing of the coating materials, for example.

Lastly, the coating material compositions used in the method ought to be able to be produced easily and with very good reproducibility, and ought not to cause any environmental problems during coating material application.

### Solution

Found accordingly has been a method for producing a coating on metal surfaces wherein at least part of the surface has applied to it a coating material composition (K) which comprises
a) at least one polyhydroxyl group-containing component (A),
b) at least one component (B) having on average at least one free and/or blocked isocyanate group and having on average at least one hydrolyzable silane group of the formula (I)

—N(X—SiR″x(OR′)3-x)n(X′—SiR″y(OR′)3-y)m (I)
where
R′=hydrogen, alkyl, cycloalkyl, aryl, or aralkyl, it being possible for the carbon chain to be interrupted by nonadjacent oxygen, sulfur, or NRa groups, with Ra=alkyl, cycloalkyl, aryl, or aralkyl, preferably R′=ethyl and/or methyl,
X, X′=linear and/or branched alkylene or cycloalkylene radical having 1 to 20 carbon atoms, preferably X, X′=alkylene radical having 1 to 4 carbon atoms,
R″=alkyl, cycloalkyl, aryl, or aralkyl, it being possible for the carbon chain to be interrupted by nonadjacent oxygen, sulfur, or NRa groups, with Ra=alkyl, cycloalkyl, aryl or aralkyl, preferably R″=alkyl radical, more particularly having 1 to 6 C atoms, n=0 to 2, m=0 to 2, m+n=2, and x, y=0 to 2, and
c) at least one phosphorus-containing catalyst (D) for the crosslinking of silane groups,
   which comprises
   i. applying the coating material composition (K) to wheel rims,
   ii. 5 to 50 mol % of the isocyanate groups originally present in component (B) having undergone reaction to form silane groups of the formula (I), and
   iii. the phosphorus-containing catalyst (D) being selected from the group of phosphorus-containing acids and/or the partial esters of phosphorus-containing acids.

The present invention also provides the coatings obtainable by this method. Preferred embodiments are apparent from the description which follows and from the dependent claims.

It was surprising and was not foreseeable that the coatings produced with the method of the invention display improved resistances in the above-described laboratory test to simulate the soiling conditions during the braking procedure of a motor vehicle.

Additionally, the resulting coated metal surfaces are dirt-repellent and easy to clean and are distinguished by a high gloss, good scratch resistance, and surface hardness. Furthermore, the coated surfaces meet the requirements customarily imposed in the automobile finishing sector and also, in particular, in the wheel rim coating sector, such as, for example, high colorfastness on thermal curing of the coating materials.

Lastly, the coating material compositions used in the method can be produced easily and with very good reproducibility and do not cause any environmental problems during coating material application.

### DESCRIPTION OF THE INVENTION

### The Inventively Employed Coating Materials

To determine the nonvolatile fraction of the individual components (A) or (B) or (C) or (E) of the coating material, an amount of 1 g of the respective sample of the respective component (A) or (B) or (C) or (E) is applied to a solids-content lid and is heated at 130° C. for 1 h, then cooled to room temperature and weighed again (in accordance with ISO 3251). The binder content of the component in wt % is then obtained correspondingly from 100 multiplied by the ratio of the weight of the residue of the respective sample after drying at 130° C. divided by the weight of the respective sample prior to drying. The nonvolatile fraction was determined, for example, for corresponding polymer solutions or resins present in the coating composition of the invention, in order thereby to be able to adjust and determine the weight fraction of the respective constituent in a mixture of two or more constituents or in the coating composition as a whole. In the case of commercial components, the binder content of this component may also be equated with sufficient accuracy with the stated solids content, unless otherwise indicated.

The binder content of the coating material composition is in each case the total binder content of components (A) plus (B) plus (C) plus (E) of the coating material composition prior to crosslinking. It is calculated, in a manner known to the skilled person, from the binder fraction of these components (A) or (B) or (C) or (E) and the amount of the respective component (A) or (B) or (C) or (E) that is used in each case in 100 parts by weight of the coating material composition. The binder content of the coating material composition in parts by weight is therefore equal to the sum of the products of the amount of the respective component (A) or (B) or (C) or (E) used in each case in 100 parts by weight of the coating material composition, in each case multiplied by the binder content of the respective component (A) or (B) or (C) or (E) in wt %, and divided in each case by 100.

For the purposes of the invention, the hydroxyl number or OH number indicates the amount of potassium hydroxide, in milligrams, which is equivalent to the molar amount of acetic acid bound during acetylation of one gram of the constituent in question. For the purposes of the present invention, unless otherwise indicated, the hydroxyl number is determined experimentally by titration in accordance with DIN 53240-2: 2007-11 (Determination of hydroxyl value—Part 2: Method with catalyst).

For the purposes of the invention, the acid number indicates the amount of potassium hydroxide, in milligrams, which is needed to neutralize 1 g of the respective constituent. For the purposes of the present invention, unless indicated otherwise, the acid number is determined experimentally by titration in accordance with DIN EN ISO 2114: 2006-11.

The mass-average (Mw) and number-average (Mn) molecular weight is determined for the purposes of the present invention by means of gel permeation chromatography at 35° C., using a high-pressure liquid chromatography pump and a refractive index detector. The eluent used was tetrahydrofuran containing 0.1 vol % acetic acid, with an elution rate of 1 ml/min. The calibration is carried out using polystyrene standards.

For the purposes of the invention, the glass transition temperature, Tg, is determined experimentally on the basis of DIN 51005 “Thermal Analysis (TA)—Terms” and DIN EN ISO 11357-2 “Thermal analysis—Dynamic Scanning Calorimetry (DSC)”. This involves weighing out a 10 mg sample into a sample boat and introducing it into a DSC instrument. The instrument is cooled to the start temperature, after which a 1st and 2nd measurement run is carried out under inert gas flushing (N2) at 50 ml/min with a ̂eating rate of 10 K/min, with cooling to the start temperature again between the measurement runs. Measurement takes place customarily in the temperature range from about 50° C. lower than the anticipated glass transition temperature to about 50° C. higher than the glass transition temperature. The glass transition temperature recorded for the purposes of the present invention, in line with DIN EN ISO 11357-2, section 10.1.2, is the temperature in the 2nd measurement run at which half of the change in the specific heat capacity (0.5 delta cp) is reached. This temperature is determined from the DSC diagram (plot of the thermal flow against the temperature), and is the temperature at the point of intersection of the midline between the extrapolated base lines, before and after the glass transition, with the measurement plot.

### The Polyhydroxyl Group-Containing Component (A)

As polyhydroxyl group-containing component (A) it is possible to use all compounds known to the skilled person which have at least 2 hydroxyl groups per molecule and are oligomeric and/or polymeric. As component (A) it is also possible to use mixtures of different oligomeric and/or polymeric polyols.

The preferred oligomeric and/or polymeric polyols (A) have number-average molecular weights Mn>=300 g/mol, preferably Mn=400-30 000 g/mol, more preferably Mn=500-15 000 g/mol, and mass-average molecular weights Mw>500 g/mol, preferably between 800 and 100 000 g/mol, more particularly between 900 and 50 000 g/mol, as measured by gel permeation chromatography (GPC) against a polystyrene standard.

Preferred as component (A) are polyester polyols, polyacrylate polyols and/or polymethacrylate polyols, and also copolymers thereof—referred to below as polyacrylate polyols; and polyurethane polyols, polysiloxane polyols, and mixtures of these polyols.

The polyols (A) preferably have an OH number of 30 to 400 mg KOH/g, more particularly between 70 and 250 mg KOH/g. In the case of the poly(meth)acrylate copolymers, the OH number may also be determined with sufficient accuracy by calculation on the basis of the OH-functional monomers used.

The polyols (A) preferably have an acid number of between 0 and 30 mg KOH/g.

The glass transition temperatures, measured by means of the above-described DSC measurements, of the polyols are preferably between −150 and 100° C., more preferably between −40° C. and 60° C.

Polyurethane polyols are prepared preferably by reaction of oligomeric polyols, more particularly of polyester polyol prepolymers, with suitable di- or polyisocyanates, and are described in EP-A-1 273 640, for example. Used in particular are reaction products of polyester polyols with aliphatic and/or cycloaliphatic di- and/or polyisocyanates.

The polyurethane polyols used with preference in accordance with the invention have the number-average molecular weight Mn>=300 g/mol, preferably Mn=700-2000 g/mol, more preferably Mn=700-1300 g/mol, and also, preferably, a mass-average molecular weight Mw>500 g/mol, preferably between 1500 and 3000 g/mol, more particularly between 1500 and 2700 g/mol, in each case measured by gel permeation chromatography (GPC) against a polystyrene standard.

Suitable polysiloxane polyols are described in WO-A-01/09260, for example, and the polysiloxane polyols recited therein can be employed preferably in combination with further polyols, especially those with relatively high glass transition temperatures.

Polyhydroxyl group-containing components (A) used with particular preference are polyester polyols, polyacrylate polyols, polymethacrylate polyols, polyurethane polyols, or mixtures thereof, and very preferably mixtures of poly(meth)acrylate polyols.

The polyester polyols (A) that are used with preference in accordance with the invention have a number-average molecular weight Mn>=300 g/mol, preferably Mn=400-10 000 g/mol, more preferably Mn=500-5000 g/mol, and also, preferably, a mass-average molecular weight Mw>500 g/mol, more preferably between 800 and 50 000 g/mol, more particularly between 900 and 10 000 g/mol, measured in each case by gel permeation chromatography (GPC) against a polystyrene standard.

The polyester polyols (A) used with preference in accordance with the invention preferably have an OH number of 30 to 400 mg KOH/g, more particularly between 100 and 250 mg KOH/g.

The polyester polyols (A) used with preference in accordance with the invention preferably have an acid number of between 0 and 30 mg KOH/g.

Suitable polyester polyols are also described in EP-A-0 994 117 and EP-A-1 273 640, for example.

The poly(meth)acrylate polyols (A) used with preference in accordance with the invention are generally copolymers and preferably have a number-average molecular weight Mn>=300 g/mol, preferably Mn=500-15 000 g/mol, more preferably Mn=900-10 000 g/mol, and also, preferably, mass-average molecular weights Mw of between 500 and 20 000 g/mol, more particularly between 1000 and 15 000 g/mol, measured in each case by gel permeation chromatography (GPC) against a polystyrene standard.

The poly(meth)acrylate polyols (A) preferably have an OH number of 60 to 300 mg KOH/g, more particularly between 70 and 250 mg KOH/g, and also an acid number of between 0 and 30 mg KOH/g.

The hydroxyl number (OH number) and the acid number are determined as described above (DIN 53240-2 and DIN EN ISO 2114: 2006-11).

Monomer units suitable for the poly(meth)acrylate polyols (A) used with preference in accordance with the invention are identified, for example, in WO2014/016019 on pages 10 and 11 and also in WO2014/016026 on pages 11 and 12.

Used in particular in accordance with the invention are coating material compositions (K) which comprise as component (A) one or more poly(meth)acrylate polyols (A1) having a glass transition temperature of between −100 and <30° C., preferably below 10° C., more particularly between −60° C. to 5° C., and more preferably between −30° C. and <0° C. (measured using the above-described DSC measurements). Additionally the coating material compositions (K) may further comprise one or more different poly(meth)acrylate polyols (A2), preferably poly(meth)acrylate polyols (A2) which have a glass transition temperature of 10 to 70° C. (measured by the above-described DSC measurements). The glass transition temperature may initially also be estimated theoretically by the skilled person, with the aid of the Fox equation (III) below, but is then to be determined experimentally as described above:

$$1 / {T}_{g} = {\sum }_{n = 1}^{n = x} {W}_{n} / {T}_{g n} \qquad ( III )$$

where
T_{q}=glass transition temperature of the polyacrylate or polymethacrylate, x=number of different copolymerized monomers, Wₙ=weight fraction of the nth monomer, T_{gn}=glass transition temperature of the homopolymer of the nth monomer.

The component (A) preferably comprises at least one (meth)acrylate copolymer which is obtainable by copolymerizing

(a) 10 to 80 wt %, preferably 20 to 50 wt %, of a hydroxyl-containing ester of acrylic acid or mixtures of these monomers,
(b) 0 to 30 wt %, preferably 0 to 15 wt %, of a non-(a) hydroxyl-containing ester of methacrylic acid or of a mixture of such monomers,
(c) 5 to 90 wt %, preferably 20 to 70 wt %, of a non-(a) and non-(b) aliphatic or cycloaliphatic ester of (meth)acrylic acid having at least 4 carbon atoms in the alcohol residue, or of a mixture of such monomers,
(d) 0 to 5 wt %, preferably 0.5 to 3.5 wt %, of an ethylenically unsaturated carboxylic acid or of a mixture of ethylenically unsaturated carboxylic acids,
(e) 0 to 50 wt %, preferably 0 to 20 wt %, of a vinylaromatic or of a mixture of such monomers, and
(f) 0 to 50 wt %, preferably 0 to 35 wt %, of an ethylenically unsaturated monomer other than (a), (b), (c), (d), and (e), or of a mixture of such monomers,
the sum of the weight fractions of components (a), (b), (c), (d), (e), and (f) always making 100 wt %, and also optionally one or more (meth)acrylate copolymers different therefrom.

### Component (B)

The coating materials of the invention comprise a component (B) having on average at least one isocyanate group and having on average at least one hydrolyzable silane group. The coating materials of the invention preferably comprise a component (B) having on average at least one free isocyanate group. However, the isocyanate groups of component (B) may also be used in blocked form. This is preferably the case when the coating materials of the invention are used as one-component systems. For the blocking it is possible in principle to use any blocking agent which can be used for the blocking of polyisocyanates and which has a sufficiently low deblocking temperature. Such blocking agents are familiar to the skilled person. For example, the isocyanate groups may be blocked using substituted pyrazoles, more particularly with alkyl-substituted pyrazoles, such as 3-methylpyrazole, 3,5-dimethylpyrazole, 4-nitro-3,5-dimethypyrazole, 4-bromo-3,5-dimethylpyrazole, and the like.

The di- and/or polyisocyanates that serve as parent structures for the component (B) used with preference in accordance with the invention are preferably conventional substituted or unsubstituted aromatic, aliphatic, cycloaliphatic and/or heterocyclic polyisocyanates, more preferably aliphatic and/or cycloaliphatic polyisocyanates. Additionally preferred are the polyisocyanate parent structures derived from an aliphatic and/or cycloaliphatic diisocyanate of this kind by dimerization, trimerization, biuret formation, uretdione formation, allophanate formation and/or isocyanurate formation.

The di- and/or polyisocyanates serving as parent structures for the component (B) used with preference in accordance with the invention are described for example in WO2014/016019 on pages 12 and 13 and also in WO2014/016026 on pages 13 and 14.

Di- and/or polyisocyanates serving with particular preference as parent structures for the component (B) used with preference in accordance with the invention are hexamethylene 1,6-diisocyanate, isophorone diisocyanate, and 4,4′-methylenedicyclohexyl diisocyanate, or mixtures of these isocyanates, and/or one or more polyisocyanate parent structures derived from such an isocyanate by dimerization, trimerization, biuret formation, uretdione formation, allophanate formation and/or isocyanurate formation. More particularly the polyisocyanate parent structure is 1,6-hexamethylene diisocyanate, 1,6-hexamethylene diisocyanate isocyanurate, 1,6-hexamethylene diisocyanate uretdione, isophorone diisocyanate, isophorone diisocyanate isocyanurate, or a mixture of two or more of these polyisocyanates, more preferably 1,6-hexamethylene diisocyanate isocyanurate.

In a further embodiment of the invention, the polyisocyanates are polyisocyanate prepolymers with urethane structural units, which are obtained by reaction of polyols with a stoichiometric excess of aforesaid polyisocyanates. Polyisocyanate prepolymers of this kind are described for example in U.S. Pat. No. 4,598,131.

It is essential to the invention that component (B) has on average at least one free or blocked isocyanate group and additionally on average at least one silane group of the formula (I)

—N(X—SiR″x(OR′)3-x)n(X′—SiR″y(OR′)3-y)m (I)

where
R′=hydrogen, alkyl, cycloalkyl, aryl, or aralkyl, it being possible for the carbon chain to be interrupted by nonadjacent oxygen, sulfur, or NRa groups, with Ra=alkyl, cycloalkyl, aryl, or aralkyl, preferably R′=ethyl and/or methyl,
X, X′=linear and/or branched alkylene or cycloalkylene radical having 1 to 20 carbon atoms, preferably X, X′ alkylene radical having 1 to 4 carbon atoms,
R″=alkyl, cycloalkyl, aryl, or aralkyl, it being possible for the carbon chain to be interrupted by nonadjacent oxygen, sulfur, or NRa groups, with Ra=alkyl, cycloalkyl, aryl, or aralkyl, preferably R″=alkyl radical, more particularly having 1 to 6 C atoms,
n=0 to 2, m=0 to 2, m+n=2, and x, y=0 to 2.

The structure of these silane radicals as well affects the reactivity and hence also the very substantial reaction during the curing of the coating. With regard to the compatibility and the reactivity of the silanes, silanes having 3 hydrolyzable groups are used with preference, i.e., x, y=0.

The respective preferred alkoxy radicals (OR′) may be alike or different; critical for the construction of the radicals, however, is the extent to which they influence the reactivity of the hydrolyzable silane groups. Preferably R′ is an alkyl radical, more particularly having 1 to 6 C atoms. Particularly preferred radicals R′ are those which raise the reactivity of the silane groups, i.e., which represent good leaving groups. A methoxy radical is therefore preferred over an ethoxy radical, which is preferred in turn over a propoxy radical. With particular preference, therefore, R′=ethyl and/or methyl, more particularly methyl.

The reactivity of organofunctional silanes may also be considerably influenced, furthermore, by the length of the spacers X, X′ between silane functionality and organic functional group serving for reaction with the constituent to be modified. Exemplary of this are the “alpha”-silanes, which are available from Wacker and in which there is a methylene group between Si atom and functional group, rather than the propylene group present in the case of “gamma”-silanes.

Component (B) preferably has on average at least one isocyanate group and also, additionally, on average at least one structural unit (I) of the formula (I)

—N(X—SiR″ₓ(OR′)₃₋ₓ)ₙ(X′—SiR″_{y}(OR′)_{3-y})ₘ (I),

and
at least one structural unit (II) of the formula (II)

—NR—(X—SiR″ₓ(OR′)₃₋ₓ) (II),

where
R=hydrogen, alkyl, cycloalkyl, aryl, or aralkyl, it being possible for the carbon chain to be interrupted by nonadjacent oxygen, sulfur, or NRa groups, with Ra=alkyl, cycloalkyl, aryl or aralkyl,
R′=hydrogen, alkyl, or cycloalkyl, it being possible for the carbon chain to be interrupted by nonadjacent oxygen, sulfur, or NRa groups, with Ra=alkyl, cycloalkyl, aryl or aralkyl, preferably R′=ethyl and/or methyl,
X, X′=linear and/or branched alkylene or cycloalkylene radical having 1 to 20 carbon atoms, preferably X, X′=alkylene radical having 1 to 4 carbon atoms,
R″=alkyl, cycloalkyl, aryl, or aralkyl, it being possible for the carbon chain to be interrupted by nonadjacent oxygen, sulfur, or NRa groups, with Ra=alkyl, cycloalkyl, aryl or aralkyl, preferably R″=alkyl radical, more particularly having 1 to 6 C atoms,
n=0 to 2, m=0 to 2, m+n=2, and x, y=0 to 2.

More preferably component (B) has on average at least one isocyanate group and also on average one structural unit (I) of the formula (1) and on average one structural unit (II) of the formula (II).

Component (B) consists generally of a mixture of different compounds and has only on average at least one structural unit (I) of the formula (I) and optionally on average at least one structural unit (II) of the formula (II) and on average at least one, preferably more than one, isocyanate group. In particular, therefore, component (B) consists of a mixture of at least one compound (B1) having more than one isocyanate group and containing no structural units (I) and (II), with

1. at least one compound (B2) which has at least one isocyanate group and at least one structural unit (I), and optionally at least one compound (B3) which has at least one isocyanate group and at least one structural unit (II), and/or with
2. at least one compound (B4) which has at least one structural unit (I) and at least one structural unit (II) and also has no isocyanate group, and/or with
3. at least one compound (B5) which has at least one isocyanate group and at least one structural unit (I) and at least one structural unit (II), and/or with
4. at least one compound (B6) which has at least one structural unit (I) and also has no isocyanate group, and optionally at least one compound (B7) which has at least one structural unit (II) and also has no isocyanate group.

It is essential to the invention that, in component (B), between 5 and 50 mol %, preferably between 10 and 50 mol %, more preferably between 15 and 45 mol %, and very preferably 20 to 45 mol % of the isocyanate groups originally present have undergone reaction to form bissilane structural units of the formula (I).

In component (B) preferably between 10 and 90 mol %, more particularly between 15 and 70 mol %, preferably between 20 and 65 mol %, more preferably between 25 and 60 mol %, of the isocyanate groups originally present have undergone reaction to form structural units (I) and (II).

In addition, in component (B), in the total amount of bissilane structural units (I) is between 6 and 100 mol %, preferably between 13 and 98 mol %, more preferably between 23 and 95 mol %, very preferably between 30 and 90 mol %, based in each case on the entirety of the structural units (I) plus (II), and the total amount of monosilane structural units (II) is between 94 and 0 mol %, preferably between 87 and 2 mol %, more preferably between 77 and 5 mol %, more preferably between 70 and 10 mol %, based in each case on the entirety of the structural units (I) plus (II).

The components (B) used in accordance with the invention and functionalized with the structural units (I) and optionally (II) are obtained in particular by reaction of—preferably aliphatic—polyisocyanates, and/or the polyisocyanates derived therefrom by trimerization, dimerization, urethane formation, biuret formation, uretdione formation and/or allophanate formation, with at least one compound of the formula (Ia)

HN(X—SiR″ₓ(OR′)₃₋ₓ)ₙ(X′—SiR″_{y}(OR′)_{3-y})ₘ (Ia),

and optionally with at least one compound of the formula (IIa)

H—NR—(X—SiR″ₓ(OR′)₃₋ₓ) (IIa),

the substituents having the definition stated above.

The components (B) used with particular preference in accordance with the invention and functionalized with the structural units (I) and (II) are obtained with particular preference by reaction of aliphatic polyisocyanates and/or the polyisocyanates derived therefrom by trimerization, dimerization, urethane formation, biuret formation, uretdione formation and/or allophanate formation with at least one compound of the formula (Ia) and with at least one compound of the formula (IIa), the substituents having the definition stated above.

In this context it is possible, for the preparation of component (B), to react directly the total amount of the di- and/or polyisocyanate used in preparing component (B) with the mixture of at least one compound (Ia) and at least one compound (IIa). Furthermore, to prepare component (B), it is also possible to react the total amount of the di- and/or polyisocyanate used in preparing component (B) first with at least one compound (Ia) or (IIa) and thereafter with at least one compound (IIa) or (Ia).

Furthermore, for preparing component (B), it is possible first to react only part of the total amount of the di- and/or polyisocyanate used in preparing component (B) with the mixture of at least one compound (Ia) and at least one compound (IIa), and subsequently to add the remaining part of the total amount of the di- and/or polyisocyanate used in preparing component (B).

Lastly, for preparing component (B), it is possible first to react only part of the total amount of the di- and/or polyisocyanate used in preparing component (B) separately with at least one compound (Ia), and to react another part of the total amount of the di- and/or polyisocyanate used in preparing component (B) separately with at least one compound (IIa), and optionally, subsequently, to add any remaining residual part of the total amount of the di- and/or polyisocyanate used in preparing component (B). It will be appreciated here that all conceivable hybrid forms of the stated reactions are possible for the preparation of component (B).

Preferably, however, component (B) is prepared alternatively by

reacting the total amount of the di- and/or polyisocyanate used in preparing component (B) with the mixture of at least one compound (Ia) and at least one compound (IIa)
or
mixing a part of the total amount of the di- and/or polyisocyanate used in preparing component (B) with a component which has been fully silanized with the compounds (Ia) and (IIa) and is therefore free of isocyanate groups and/or
mixing a part of the total amount of the di- and/or polyisocyanate used in preparing component (B) with a component which has been fully silanized with the compound (Ia) and is therefore free of isocyanate groups, and with a component which has been fully silanized with the compound (IIa) and is therefore free of isocyanate groups.

Inventively preferred compounds (Ia) are bis(2-ethyltrimethoxysilyl)amine, bis(3-propyltrimethoxysilyl)amine, bis(4-butyltrimethoxysilyl)amine, bis(2-ethyltriethoxysilyl)-amine, bis(3-propyltriethoxysilyl)amine and/or bis(4-butyltriethoxysilyl)amine. Especially preferred is bis(3-propyltrimethoxysilyl)amine. Aminosilanes of this kind are available for example under the brand name DYNASYLAN® from Evonik or Silquest® from OSI.

Inventively preferred compounds (IIa) are aminoalkyl-trialkoxysilanes, such as preferably 2-aminoethyltrimethoxysilane, 2-aminoethyltriethoxysilane, 3-aminopropvltrimethoxysilane, aminopropyltriethoxysilane, 4-aminobutyltrimethoxysilane, 4-aminobutyltriethoxysilane. Particularly preferred compounds (Ia) are N-(2-(trimethoxysilyl)ethyl)alkylamines, N-(3-(trimethoxysilyl)propyl)alkylamines, N-(4-(trimethoxysilyl)butyl)alkylamines, N-(2-(triethoxysilyl)ethyl)alkylamines, N-(3-(triethoxysilyl) propyl)alkylamines and/or N-(4-(triethoxysilyl)butyl)alkylamines. Especially preferred is N-(3-(trimethoxysilyl)propyl)butylamine. Aminosilanes of this kind are available for example under the brand name DYNASYLAN® from Evonik or Silquest® from OSI.

### The Hydroxyl Group-Containing Component (C)

Optionally, as well as the polyhydroxyl group-containing component (A), the coating material compositions of the invention may comprise one or more monomeric, hydroxyl group-containing components (C) that are different from component (A). These components (C) preferably occupy a fraction of 0 to 10 wt %, more preferably of 0 to 5 wt %, based in each case on the binder content of the coating material composition.

Low molecular mass polyols are used as hydroxyl group-containing component (C). Low molecular mass polyols used are, for example, diols, such as preferably ethylene glycol, di- and triethylene glycol, neopentyl glycol, 1,2-propanediol, 2,2-dimethyl-1,3-propanediol, 1,4-butanediol, 1,3-butanediol, 1,5-pentanediol, 2,2,4-trimethyl-1,3-pentanediol, 1,6-hexanediol, 1,4-cyclohexanedimethanol, and 1,2-cyclohexanedimethanol, and also polyols, such as preferably trimethylolethane, trimethylolpropane, trimethylolhexane, 1,2,4-butanetriol, pentaerythritol, and dipentaerythritol. Low molecular mass polyols (C) of this kind are admixed preferably in minor fractions to the polyol component (A).

### The Catalyst (D)

It is essential to the invention that phosphorus-containing catalysts and/or partial esters of phosphorus-containing acids are used as catalyst (D). Mixtures of two or more different catalysts (D) may also be used here.

As catalyst D), alkylphosphonic acids, dialkylphosphinic acids, phosphoric acid, diphosphonic acid, phosphinic acid, optionally substituted acyclic phosphoric monoesters and/or optionally substituted cyclic phosphoric monoesters and/or optionally substituted acyclic phosphoric diesters and/or optionally substituted acyclic phosphoric diesters, are used for example.

Preferred for use are optionally substituted acyclic phosphoric monoesters and/or optionally substituted cyclic phosphoric monoesters and/or optionally substituted acyclic phosphoric diesters and/or optionally substituted acyclic phosphoric diesters, especially acyclic phosphoric diesters and cyclic phosphoric diesters. Use is made here more particularly of partial esters (D) of phosphoric acid, of the general formula (V):

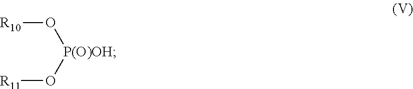

where the radicals R₁₀ and R₁₁ are selected from the group consisting of:
substituted and unsubstituted alkyl having 1 to 20, preferably 2 to 16, and more particularly 2 to 10 carbon atoms, cycloalkyl having 3 to 20, preferably 3 to 16, and more particularly 3 to 10 carbon atoms, and aryl having 5 to 20, preferably 6 to 14, and more particularly 6 to 10 carbon atoms,
substituted and unsubstituted alkylaryl, arylalkyl, alkylcycloalkyl, cycloalkylalkyl, arylcycloalkyl, cycloalkylaryl, alkylcycloalkylaryl, alkylarylcycloalkyl, arylcycloalkylalkyl, arylalkylcycloalkyl, cycloalkylalkylaryl, and cycloalkylarylalkyl, where the alkyl, cycloalkyl, and aryl groups present therein each contain the number of carbon atoms set out above, and
substituted and unsubstituted radical of the aforementioned kind, comprising at least one, more particularly one, heteroatom selected from the group consisting of oxygen atom, sulfur atom, nitrogen atom, phosphorus atom, and silicon atom, more particularly oxygen atom, sulfur atom, and nitrogen atom,
   and additionally one of the radicals, R₁₀ or R₁₁, may also be hydrogen.

Especially preferred for use are partial esters (D) of phosphoric acid, of the general formula (V), in which the radicals R₁₀ and R₁₁ are selected from the group consisting of substituted and unsubstituted alkyl having 1 to 20, preferably 2 to 16, and more particularly 2 to 10 carbon atoms, cycloalkyl having 3 to 20, preferably 3 to 16, and more particularly 3 to 10 carbon atoms, and aryl having 5 to 20, preferably 6 to 14, and more particularly 6 to 10 carbon atoms, and especially bis(2-ethylhexyl) phosphate and/or bisphenyl phosphate.

The catalyst (D) or—if a mixture of two or more catalysts (D) is used—catalysts (D) are used preferably in fractions of 0.1 to 5.0 wt %, more preferably in fractions of 0.5 to 2.5 wt %, based on the binder content of the coating material composition.

### The Catalyst (N)

Preferably, the coating material composition (K) additionally further comprises at least one phosphorus- and nitrogen-containing catalyst (N) that is different from the accelerator (R), the catalyst (D), and the catalyst (Z).

Examples of suitable phosphorus- and nitrogen-containing catalysts (N) that are different from the catalyst (D) are the amine adducts of optionally substituted phosphonic diesters and the amnine adducts of optionally substituted diphosphonic diesters, preferably from the group consisting of amine adducts of acyclic phosphonic diesters, of cyclic phosphonic diesters, of acyclic diphosphoric diesters, and of cyclic diphosphonic diesters. Catalysts of these kinds are described for example in German patent application DE-A-102005045228.

Used in particular as catalyst (N), however, are amine adducts of optionally substituted phosphoric monoesters and/or amine adducts of optionally substituted phosphoric diesters, preferably from the group consisting of amine adducts of acyclic phosphoric monoesters and amine adducts of cyclic phosphoric monoesters and amine adducts of acylic phosphorus diesters and amine adducts of cyclic phosphoric diesters.

Especially preferred for use as catalyst (N) are amine-blocked ethylhexyl phosphates and amine-blocked phenyl phosphates, very preferably amine-blocked bis(2-ethylhexyl) phosphates.

Examples of amines with which the phosphoric esters are blocked are, in particular, tertiary amines, examples being bicyclic amines, such as diazabicyclooctane (DABCO), diazabicyclononene (DEN), diazabicycloundecene (DBU), and/or trialkylamines, such as dimethyldodecylamine or triethylamine, for example. With particular preference the phosphoric esters are blocked using tertiary amines which ensure high activity of the catalyst under the curing conditions of 140° C. and/or which ensure easy removal from the coating film of the amine that is liberated during curing. Used with very particular preference, especially at low curing temperatures of not more than 90° C., to block the phosphoric esters are bicyclic amines, especially diazabicyclooctane (DABCO), and/or triethylamine.

Certain amine-blocked phosphoric acid catalysts are also available commercially (e.g., Nacure products from King Industries). An example which may be given is that known under the name Nacure 4167 from King Industries, as a particularly suitable catalyst, based on an amine-blocked partial ester of phosphoric acid.

The catalyst (N) or—if a mixture of two or more catalysts (N) is used—the catalysts (N) are used preferably in fractions of 0.1 to 15 wt %, more preferably in fractions of 1.0 to 8.0 wt %, based on the binder content of the coating material composition. A lower activity on the part of the catalyst may be partly compensated by correspondingly higher quantities employed.

### The Accelerator (R)

Especially if the inventively employed coating material compositions are cured at relatively low temperatures of up to 90° C., it is advantageous if the coating material compositions include at least one accelerator (R). Accelerators (R) used may be any components that are different from the catalyst (D), the catalyst (N) and the catalyst (Z) and that accelerate the reaction of the isocyanate groups of component (B) with the hydroxyl groups of component (A) and optionally (C), and/or accelerate the reaction of the alkoxysilane groups.

Especially suitable as accelerators (R) are inorganic phosphorus-free acids and/or organic acids and/or partial esters of inorganic phosphorus-free acids and/or partial esters of organic acids. Preferred accelerators (R) are organic acids and/or partial esters of organic acids. Acids used are, in particular, sulfonic acids, such as dodecylbenzenesulfonic acid and toluenesulfonic acid, for example, and/or monomeric aromatic, optionally substituted carboxylic acids.

Preferred as accelerators (R) for use are monomeric aromatic, optionally substituted carboxylic acids whose carboxyl group is in conjugation with a π-electron system, such as, for example, benzoic acid, tert-butylbenzoic acid, 3,4-dihydroxybenzoic acid, salicylic acid and/or acetylsalicylic acid, more preferably benzoic acid.

The accelerator (R) or—if a mixture of 2 or more accelerators (R) is used—the accelerators (R) are used preferably in fractions of 0.1 to 5.0 wt %, more preferably in fractions of 0.5 to 2.5 wt %, based on the binder content of the coating material composition.

### The Catalyst (Z)

Finally, coating material composition (K) can additionally further comprise at least one catalyst (Z), different from the catalyst (D), from the accelerator (R) and from the catalyst (N), for the reaction of the hydroxyl groups with the isocyanate groups.

As catalysts (Z) for the reaction between the hydroxyl groups of component (A) and the isocyanate groups of component (B) it is possible to use compounds that are known per se. Examples are Lewis acids (electron-deficient compounds), such as tin naphthenate, tin benzoate, tin octoate, tin butyrate, dibutyltin dilaurate, dibutyltin diacetate, dibutyltin oxide, and lead-octoate.

However, the catalyst (Z) is preferably selected from the group of zinc and bismuth carboxylates and also of aluminum, zirconium, titanium and/or boron chelates, of inorganic, tin-containing catalysts, and of mixtures thereof.

Catalysts (Z) based on aluminum, zirconium, titanium and/or boron chelates are known and are described for example in WO06/042585, page 10, lines 4 to 21. The compounds which form chelate ligands are organic compounds having at least two functional groups which are able to coordinate to metal atoms or metal ions. These functional groups are usually electron donors, which give up electrons to metal atoms or metal ions as electron acceptors. Suitable in principle are all organic compounds of the stated type, provided they do not deleteriously influence, let alone completely prevent, the crosslinking of the coating material compositions. Use may be made as catalysts, for example, of the aluminum chelate and zirconium chelate complexes, as described for example in the American patent U.S. Pat. No. 4,772,672 A, column 8, line 1, to column 9, line 49. Preference is given to aluminum and/or zirconium and/or titanium chelates, such as aluminum ethyl acetoacetate and/or zirconium ethyl acetoacetate, for example.

Particularly preferred catalysts (Z) are zinc(II) biscarboxylates and bismuth(III) triscarboxylates, in particular zinc(II) biscarboxylates and bismuth(III) triscarboxylates in which the carboxylate radical is selected from the group of carboxylate radicals of aliphatic linear and/or branched, optionally substituted monocarboxylic acids having 1 to 24 C atoms in the alkyl radical, and/or of aromatic, optionally substituted monocarboxylic acids having 6 to 12 C atoms in the aryl radical. The carboxylate radical largely determines the solubility of the resulting catalyst in the coating components used. Examples of suitable catalysts (Z) include the Zn(II) and Bi(III) salts of acetic acid and of formic acid. Used with particular preference as catalyst (Z) are the Zn(II) and Bi(III) salts of branched fatty acids, and especially the Bi(III) salts of branched fatty acids. The branched fatty acids of the Zn(II) and Bi(III) salts are selected more particularly from C3 to C24 fatty acids, preferably C4 to C20 fatty acids, more preferably from C6 to C16 fatty acids, and very preferably from the group of octanoic acids, especially 2-ethylhexanoic acid, and of decanoic acids, especially neodecanoic acid. Especially preferred for use as catalyst (Z) is the Bi(III) salt of C3 to C24 fatty acids. The Zn(II) and Bi(III) salt of branched fatty acids here may also be present in the form of a polynuclear complex.

Certain Zn(II) and Bi(III) salts of branched fatty acids are also available commercially (e.g., Borchi® Kat products from Lanxess Corp. and K-Kat® products from King Industries). Mention may be made, for example, as particularly suitable catalysts (Z), of those under the name Coscat® 83 from C.H. Erbslöh GmbH & Co. KG, based on bismuth trisneodecanoate; under the name Borchi® Kat 24 from Lanxess Corp., based on bismuth carboxylate; under the name K-Kat® 348 from King Industries, based on bismuth carboxylate; and under the name K-Kat® XC-8203 from King Industries, likewise based on bismuth carboxylate.

Inorganic, tin-containing catalysts may also be used as catalyst (Z). Inorganic, tin-containing catalysts are, as is known, those in which the central tin atom has no metal-carbon coordination, the carbon instead being bonded via heteroatoms to the tin. Particularly preferred as inorganic, tin-containing catalysts (Z) are cyclic tin(IV) compounds having alkyl radicals and/or cycloalkyl radicals and/or aryl radicals and/or aralalkyl radicals bonded exclusively via oxygen atoms and/or nitrogen atoms and/or sulfur atoms, more particularly via oxygen atoms. The inorganic, tin-containing catalysts have the advantage of a substantially lower toxicity over organotin compounds, such as dibutyltin dilaurate, for example.

Examples of suitable inorganic, tin-containing catalysts are the thermolatent inorganic, tin-containing catalysts with cyclic structures that are described in EP-B2 493 948, page 2, line 42 to page 10, line 14. Likewise suitable are the tin-containing catalysts described in WO2014/048854, page 2, line 16, to page 9, line 15, and page 15, table 1, and those described in WO2014/048879, page 4, line 1, to page 10, line 35, and page 16, table 1.

The catalyst (Z) or—if a mixture of two or more catalysts (Z) is used—the catalysts (Z) are used preferably in fractions of 0.005 to 1.0 wt %, more preferably in fractions of 0.05 to 0.5 wt %, based on the binder content of the coating material composition. A lower activity on the part of the catalyst here can be partly compensated by correspondingly higher quantities employed.

Catalyst (D), optionally employed catalyst (Z), optionally employed accelerator (R) and optionally employed catalyst (N) are used in the coating material compositions of the invention more particularly in amounts such that the total amount of catalyst (D) plus catalyst (N) plus catalyst (Z) plus accelerator (R) is between 0.2 and 20 wt %, preferably between 0.5 and 10 wt %, and more preferably between 1.0 and 8.1 wt %, based in each case on the binder content of the coating material composition.

### The Light Stabilizers (LS)

To improve the brake dust resistance it is advantageous if the coating material compositions comprise at least one light stabilizer (LS). Suitable here are all light stabilizers customarily used in coating material compositions. More preferably the coating material compositions comprise at least one light stabilizer based on sterically hindered amines (HALS) and/or based on UV absorbers, such as triazoles, triazines, benzophenones, oxoanilides, and the like, for example. Used more particularly as light stabilizers (LS) are mixtures of at least one light stabilizer based on sterically hindered amines (LS1) and at least one light stabilizer based on UV absorbers (LS2).

The light stabilizers (LS) are used preferably in fractions of 0.55 to 15.1 wt %, more preferably in fractions of 1.1 to 11.0 wt %, based on the binder content of the coating material composition. The coating material compositions comprise more preferably a mixture of 0.05 to 6.0 wt %, more preferably 0.2 to 3.0 wt %, of the light stabilizers (LS1) based on sterically hindered amines, and 0.5 to 15.0 wt %, more preferably 0.9 to 8.0 wt %, of the light stabilizer (LS2) based on UV absorbers, based in each case on the binder content of the coating material composition.

### The Combination of Components (A), (B), Optionally (C), (D), Optionally (N), Optionally (Z), Optionally (R), and Further Components of the Coating Material Compositions

For the two-component (2K) coating material compositions that are particularly preferred in accordance with the invention, a film-forming component, comprising the polyhydroxyl group-containing component (A) and also further components described below is mixed in a conventional way with a further film-forming component, comprising component (B) and also, optionally, further of the components described below, this mixing taking place shortly before the coating material is applied; here, generally, the film-forming component which comprises component (A) comprises the catalyst (D), optionally the catalyst (N), optionally the catalyst (Z), and optionally the accelerator (R) and also a part of the solvent.

The polyhydroxyl group-containing component (A) may be present in a suitable solvent. Suitable solvents are those which allow sufficient solubility of the polyhydroxyl group-containing component.

Preference is given in accordance with the invention to using coating material compositions which comprise from 10.0 to 70.0 wt %, preferably from 20.0 to 50.0 wt %, based in each case on the binder content of the coating material composition, of at least one polyhydroxyl group-containing component (A), more particularly at least one polyhydroxyl group-containing polyacrylate (A) and/or at least one polyhydroxyl group-containing polymethacrylate (A).

Preference is given in accordance with the invention to using coating material compositions which contain from 90.0 to 30.0 wt %, preferably from 80.0 to 50.0 wt %, based in each case on the binder content of the coating material composition, of component (B) having on average at least one free and/or blocked isocyanate group and having on average at least one hydrolyzable silane group.

The coating material compositions preferably comprise components (C) in a fraction of 0 to 20 wt %, more preferably of 0 to 10 wt %, very preferably of 1 to 5 wt %, based in each case on the binder content of the coating material composition.

The weight fractions of polyol (A) and optionally (C), and of component (B) are preferably selected such that the molar equivalents ratio of the hydroxyl groups of the polyhydroxyl group-containing components (A) plus optionally (C) to the isocyanate groups of component (B) is between 1:0.5 and 1:1.5, preferably between 1:0.8 and 1:1.2, more preferably between 1:0.9 and 1:1.1.

The polyhydroxyl group-containing component (A), polyhydroxyl component (C), and/or isocyanate component (B) may be present in a suitable solvent. Suitable solvents (L) for the coating materials of the invention are especially those which in the coating material are chemically inert toward the components (A), (B), and optionally (C) and which also do not react with (A), optionally (C), and (B) during the curing of the coating material. Mention may be made in particular here of aprotic solvents. Examples of such solvents are aliphatic and/or aromatic hydrocarbons such as toluene, xylene, solvent naphtha, Solvesso 100, or Hydrosol® (from ARAL), ketones, such as acetone, methyl ethyl ketone, or methyl amyl ketone, esters, such as ethyl acetate, butyl acetate, pentyl acetate, or ethyl ethoxypropionate, ethers, or mixtures of the aforementioned solvents. The aprotic solvents or solvent mixtures preferably have a water content of not more than 1 wt %, more preferably not more than 0.5 wt %, based on the solvent.

The solvent or solvents are used preferably in the coating material compositions of the invention in an amount such that the binder content of the coating material composition is at least 50 wt %, more preferably at least 60 wt %. It should be borne in mind here that generally speaking, as the solids content becomes higher, the viscosity of the coating material composition goes up, and the leveling of the coating material composition and therefore the overall visual impression conveyed by the cured coating become poorer.

Besides components (A), (B), and optionally (C), there may also be further binders (E) used, which are able to react and form network nodes preferably with the hydroxyl groups of the poly(meth)acrylate (A) and/or with the free isocyanate groups of component (B) and/or with the alkoxysilyl groups of the component (B).

As component (E) it is possible for example to use amino resins and/or epoxy resins. Those contemplated are the customary and known amino resins some of whose methylol and/or methoxymethyl groups may have been defunctionalized by means of carbamate or allophanate groups. Crosslinking agents of this kind are described in patent specifications U.S. Pat. No. 4,710,542 and EP-B-0 245 700 and also in the article by B. Singh and coworkers, “Carbamylmethylated Melamines, Novel Crosslinkers for the Coatings Industry” in Advanced Organic Coatings Science and Technology Series, 1991, volume 13, pages 193 to 207.

In general such components (E) are used in fractions of up to 40 wt %, preferably of up to 30 wt %, more preferably of up to 25 wt %, based on the binder content of the coating material composition of the invention.

The coating material compositions of the invention preferably further comprise at least one customary and known coatings additive (F), different from components (A), (B), (D), optionally (Z), optionally (R), optionally (C), and optionally (E), in effective amounts, i.e., in amounts preferably up to 15.0 wt %, more preferably of 0 up to 5.0 wt %, based in each case on the binder content of the coating material composition.

Examples of suitable coatings additives (F) are as follows:
radical scavengers;
slip additives;
polymerization inhibitors;
defoamers;
reactive diluents other than components (A) and (C), more particularly reactive diluents which become reactive only through reaction with other constituents and/or with water, such as Incozol or aspartic esters, for example;
wetting agents other than components (A) and (C), such as siloxanes, fluorine-containing compounds, carboxylic monoesters, phosphoric esters, polyacrylic acids and copolymers thereof, or polyurethanes;
adhesion promoters;
leveling agents;
rheological assistants, based for example on customary hydrophilic and/or hydrophobic fumed silica, such as various Aerosil® products, or customary urea-based rheological assistants;
film-forming assistants such as cellulose derivatives;
fillers such as, for example, nanoparticles based on silicon dioxide, aluminum oxide, or zirconium oxide; for further details, refer to Römpp Lexikon “Lacke and Druckfarben” Georg Thieme Verlag, Stuttgart, 1998, pages 250 to 252;
flame retardants.

With particular preference the inventively employed coating materials comprise as additive less than 1 wt %, more particularly less than 0.2 wt %, very preferably less than 0.05 wt % of hydrophobizing agents, based in each case on the binder content of the coating material composition, and with very particular preference include no hydrophobizing agent at all, and more particularly no silane-based hydrophobizing agent. These hydrophobizing agents, as is known, are additives which significantly lower the surface energy of the resulting coating, i.e., which significantly increase the contact angle with water of the resultant cured coating.

Preferred coating material compositions are those which comprise

20.0 to 50.0 wt %, based on the binder content of the coating material composition, of at least one polyhydroxyl group-containing polyacrylate (A) and/or at least one polyhydroxyl group-containing polymethacrylate (A) and/or at least one polyhydroxyl group-containing polyester polyol (A) and/or one polyhydroxyl group-containing polyurethane (A),
80.0 to 50.0 wt %, based on the binder content of the coating material composition, of at least one component (B),
0 to 5 wt %, based on the binder content of the coating material composition, of the hydroxyl group-containing component (C),
0 up to 15 wt %, based on the binder content of the coating material composition, of at least one amino resin (E),
0.5 to 2.5 wt %, based on the binder content of the coating material composition of the invention, of at least one catalyst (D) for crosslinking,
optionally 1.0 to 8.0 wt %, based on the binder content of the coating material composition of the invention, of at least one catalyst (N) for crosslinking,
optionally 0.05 to 0.5 wt %, based on the binder content of the coating material composition of the invention, of at least one catalyst (Z) for crosslinking,
optionally 0.5 to 2.5 wt %, based on the binder content of the coating material composition of the invention, of at least one accelerator (R),
optionally 1.1 to 11.0 wt %, based on the binder content of the coating material composition of the invention, of at least one light stabilizer (L), and
0 to 5.0 wt %, based on the binder content of the coating material composition, of at least one customary and known coatings additive (F).

Particularly preferred coating material compositions are those which comprise

20.0 to 50.0 wt %, based on the binder content of the coating material composition, of at least one polyhydroxyl group-containing polyacrylate (A) and/or at least one polyhydroxyl group-containing polymethacrylate (A) and/or at least one polyhydroxyl group-containing polyester polyol (A) and/or one polyhydroxyl group-containing polyurethane (A),
80.0 to 50.0 wt %, based on the binder content of the coating material composition, of at least one component (B),
0 to 5 wt %, based on the binder content of the coating material composition, of the hydroxyl group-containing component (C),
0 up to 15 wt %, based on the binder content of the coating material composition, of at least one amino resin (E),
0.5 to 2.5 wt %, based on the binder content of the coating material composition of the invention, of at least one catalyst (D),
1.0 to 8.0 wt %, based on the binder content of the coating material composition of the invention, of at least one catalyst (N) for crosslinking,
0 to 0.5 wt %, based on the binder content of the coating material composition of the invention, of at least one catalyst (Z) for crosslinking,
1.1 to 11.0 wt %, based on the binder content of the coating material composition of the invention, of at least one light stabilizer (L), and
0 to 5.0 wt %, based on the binder content of the coating material composition, of at least one customary and known coatings additive (F).

More particularly, the inventively employed coating materials are transparent coating materials, preferably clearcoat materials. The inventively employed coating materials therefore contain no pigments, or comprise only organic transparent dyes or transparent pigments.

In a further embodiment of the invention, the inventively employed coating material composition may also comprise further pigments and/or fillers and may serve for producing pigmented topcoats and/or pigmented undercoats or primer-surfacers, more particularly pigmented topcoats. The pigments and/or fillers employed for these purposes are known to the skilled person. The pigments are customarily used in an amount such that the pigment-to-binder ratio is between 0.05:1 and 1.5:1, based in each case on the binder content of the coating material composition.

The coating material compositions are used in accordance with the invention for coating wheel rims of any kind, more particularly steel rims and aluminum rims, very preferably aluminum rims.

The application of the inventively employed coating material compositions may take place by any customary application techniques, such as spraying, knife coating, spreading, pouring, dipping, impregnating, trickling, or rolling, for example. With respect to such application, the substrate to be coated may itself be at rest, with the application unit or equipment being moved. Alternatively, the substrate to be coated, more particularly a coil, may be moved, with the application unit being at rest relative to the substrate or being moved appropriately. Preference is given to employing spray application techniques, such as, for example, compressed air spraying, airless spraying, high-speed rotation, electrostatic spray application (ESTA), alone or in conjunction with hot spray application such as hot air spraying, for example.

The curing of the applied coating materials may take place after a certain rest time. The rest time serves, for example, for the leveling and degassing of the coating films or for the evaporation of volatile constituents such as solvents. The rest time may be assisted and/or shortened through the application of elevated temperatures and/or through a reduced atmospheric humidity, provided this does not entail any instances of damage to or change in the coating films, such as a premature complete crosslinking. The thermal curing of the coating materials has no peculiarities in terms of method, but instead takes place in accordance with the customary and known methods such as heating in a forced air oven or irradiation using IR lamps. This thermal curing may also take place in stages. Another preferred curing method is that of curing with near infrared (NIR) radiation.

The thermal curing takes place advantageously at a temperature of 20 to 200° C., preferably 20 to 90° C., for a time of 1 min up to 10 h, preferably 20 min to 60 min; at low temperatures, longer curing times may also be employed. For the finishing of wheel rims, it is customary here to employ relatively low temperatures, of preferably between 20 and 100° C., more preferably between 20 and 90° C.

The transparent coating materials used with preference in accordance with the invention may be applied directly to the metal surface of the wheel rims. However, it is also possible to apply them onto already coated wheel rims, more particularly onto wheel rims coated with pigmented basecoat material. Not only water-permeable basecoat materials but also basecoat materials based on organic solvents can be used. Suitable basecoat materials are described for example in EP-A-0 692 007 and in the documents recited in column 3, lines 50 ff. therein. Preferably, the applied basecoat material is initially dried, meaning that at least part of the organic solvent and/or of the water is removed from the basecoat film in an evaporation phase. Drying takes place preferably at temperatures from room temperature to 80° C. After the drying, the transparent coating material composition is applied. Subsequently, the two-coat paint system is baked at temperatures of 20 to 200° C. for a time of 1 min up to 10 h, employing preferably lower temperatures, between 20 and 90° C., and correspondingly longer curing times, of 20 min to 60 min.

### Examples

### Method and Apparatus for Determining the Brake Dust Resistance

For a brake dust corresponding to the average of the abrasion generated in central Europe, the following mixture is utilized:

| | | |
|---|---|---|
| Iron powder | 42.8 | g |
| Carbon | 11.2 | g |
| Fe(II) oxide | 5.9 | g |
| Fe(III) oxide | 5.9 | g |
| Fe(II/III) oxide | 5.9 | g |
| Cu(II) oxide | 14.2 | g |
| Zn(II) oxide | 3.6 | g |

The purity of the materials used is more than 95%, the simulated brake dust being mixed on a LABINCO By Rolling Bench mixer (2 Rolls, 100 watts, 230 volts, 50/60 Hz).

Using an inert carrier gas (nitrogen), the brake dust, stored in an oven and brought to the desired temperature (350° C.), is applied by means of an application gun (Wagner powder application gun, without nozzle attachment) to the sample panel coated with the coating material under test and heated to 120° C. (application time generally 5 seconds). The application rate and time are monitored using a control unit accessory to the gun, from Wagner. The gun is a fixed installation and is mounted together with the sample panel in a fume unit. The brake dust stored in the oven is swirled up and fluidized by the flow of carrier gas being directed against the bed of solids.

After soiling has taken place, the metal test panels are introduced into the accelerated UVA weathering chamber, where they are exposed for a time of 200 hours. This takes place without the buildup of brake dust being cleaned off, since only in this way is it possible to simulate the effect of hot application in connection with atmospheric humidity and irradiation. Weathering takes place according to UVA-340 testing to ASTM G154-06, DIN EN ISO 4892-1, DIN EN ISO 4892-3.

In a last step, the sample panels are cleaned under running water, after weathering has taken place, and are wiped down using a lint-free cloth.

The combination of soiling, weathering and cleaning is repeated until the desired exposure (and, in connection therewith, the desired damage pattern) is produced. In order to determine the maximum exposure, a standard is treated in a sufficient number of cycles to reproduce the desired field soiling pattern. The number of cycles needed to achieve this is then defined as the minimum requirement for the new coating system.

The metal test panels are evaluated visually. Where no markings/changes to the coating material surface can be found, the sample is classed as satisfactory and receives a rating of 1. In the case of a small number of marks, the rating 2 is awarded. If the sample surface is significantly marked with brake dust inclusions, it receives a rating of 3 and is considered unsatisfactory.

### Preparation of a Polyacrylate Polyol (A1)

A 5 l Juvo reaction vessel with heating jacket, thermometer, stirrer, and top-mounted condenser was charged with 828.24 g of an aromatic solvent (Solventnaphtha®). With stirring and under an inert gas atmosphere (200 cm³/min nitrogen), the solvent was heated to 156° C. Using a metering pump, a mixture of 46.26 g of di-tert-butyl peroxide and 88.26 g of Solventnaphtha® was added uniformly dropwise over the course of 4.50 h. 0.25 h after the beginning of the addition, using a metering pump, 246.18 g of styrene, 605.94 g of n-butyl acrylate, 265.11 g of n-butyl methacrylate, 378.69 g of 4-hydroxybutyl acrylate, 378.69 g of hydroxyethyl acrylate, and 18.90 g of acrylic acid were added at a uniform rate over the course of 4 h. After the end of the addition, the temperature was maintained for a further 1.5 h and then the product was cooled to 80° C. The polymer solution was subsequently diluted with 143.73 g of Solventnaphtha®. The resulting resin had an acid number of 10.3 mg KOH/g (to DIN EN ISO 2114: 2006-11), an OH number of 175 mg KOH/g (to DIN 53240-2), a glass transition temperature, as measured by the above-described DSC measurements to DIN EN ISO 11357-2, of −26° C., a solids content of 65%+/−1 (60 min, 130° C.), and a viscosity of 1153 mPa*s as per the test protocol of DIN ISO 2884-1 (60% in Solventnaphtha®).

### Preparation of a Polyacrylate Polyol (A2)

A 5 l Juvo reaction vessel with heating jacket, thermometer, stirrer, and top-mounted condenser was charged with 500.22 g of pentyl acetate. With stirring and under an inert gas atmosphere (200 cm³/min nitrogen), the solvent was heated to 140° C. under superatmospheric pressure (max. 3.5 bar). Using a metering pump, a mixture of 224.64 g of tert-butyl peroxy-2-ethylhexanoate and 156.00 g of Solventnaphtha® was added uniformly dropwise over the course of 4.75 h. 0.25 h after the beginning of the addition, using a metering pump, 791.46 g of hydroxypropyl methacrylate, 4.14 g of acrylic acid, 399.87 g of ethylhexyl methacrylate, 190.53 g of ethylhexyl acrylate, and 330.36 g of cyclohexyl methacrylate were added at a uniform rate over the course of 4 h. After the end of the addition, the temperature was maintained for a further 1.0 h, and the product was then cooled to 110° C. The polymer solution was subsequently diluted with a mixture of 160.20 g of Solventnaphtha® and 242.58 g of pentyl acetate. The resulting resin had an acid number of 6.3 mg KOH/g (to DIN EN ISO 2114: 2006-11), an OH number of 180 mg KOH/g (to DIN 53240-2), a glass transition temperature, as measured by the above-described DSC measurements to DIN EN ISO 11357-2, of 34° C., a solids content of 60%+/−1 (60 min, 130° C.), and a viscosity of 860 mPa*s as per the test protocol of DIN ISO 2884-1.

### Preparation of a Polyacrylate Polyol (A3)

A 5 l Juvo reaction vessel with heating jacket, thermometer, stirrer, and top-mounted condenser was charged with 828.87 g of Solventnaphtha®. With stirring and under an inert gas atmosphere (200 cm³/min nitrogen), the solvent was heated to 140° C. Using a metering pump, a mixture of 154.83 g of tert-butyl peroxy-2-ethylhexanoate and 54.99 g of Solventnaphtha® was added uniformly dropwise over the course of 4.75 h. 0.25 h after the beginning of the addition, using a metering pump, 309.93 g of styrene, 15.39 g of acrylic acid, 232.38 g of n-butyl methacrylate, 309.93 g of hydroxypropyl methacrylate, 278.85 g of hydroxyethyl methacrylate, and 402.87 g of cyclohexyl methacrylate were added at a uniform rate over the course of 4 h. After the end of the addition, the temperature was maintained for a further 1.0 h and then the product was cooled to 120° C. The polymer solution was subsequently diluted with a mixture of 236.04 g of Solventnaphtha® and 175.92 g of butyl acetate. The resulting resin had an acid number of 9.4 mg KOH/g (to DIN EN ISO 2114: 2006-11), an OH number of 156 mg KOH/g (to DIN 53240-2), a glass transition temperature, as measured by the above-described DSC measurements to DIN EN ISO 11357-2, of 67° C., a solids content of 55%+/−1 (60 min, 130° C., 66% in xylene), and a viscosity of 1130 mPa*s as per the test protocol of DIN ISO 2884-1.

### Preparation of a Polyacrylate Polyol (A4)

A 5 l Juvo reaction vessel with heating jacket, thermometer, stirrer, and top-mounted condenser was charged with 888.39 g of pentyl acetate. With stirring and under an inert gas atmosphere (200 cm³/min nitrogen), the solvent was heated to 156° C. under superatmospheric pressure (max. 3.5 bar). Using a metering pump, a mixture of 38.70 g of di-tert-butyl peroxide and 77.43 g of Solventnaphtha® was added uniformly dropwise over the course of 4.75 h. 0.25 h after the beginning of the addition, using a metering pump, 677.43 g of hydroxypropyl methacrylate, 716.13 g of ethylhexyl acrylate, 154.83 g of 4-hydroxybutyl acrylate, and 387.09 g of isobornyl methacrylate were added at a uniform rate over the course of 4 h. After the end of the addition, the polymer solution was maintained at a temperature of 140° C. for 1.0 h, and the product was then cooled to 80° C. The polymer solution was subsequently diluted with 60.00 g of pentyl acetate. The resulting resin had an acid number of 3.3 mg KOH/g (to DIN EN ISO 2114: 2006-11), an OH number of 168 mg KOH/g (to DIN 53240-2), a glass transition temperature, as measured by the above-described DSC measurements to DIN EN ISO 11357-2, of −11° C., a solids content of 64.5%+/−1 (60 min, 130° C.), and a viscosity of 450 mPa*s as per the test protocol of DIN ISO 2884-1.

### Preparation of the Curing Agent Solutions Used in Inventive Examples B1 to B9 and Comparative Example VI

A 250 ml three-neck flask with stirring magnet, internal thermometer, and dropping funnel is charged with a mixture of trimerized isocyanurate based on hexamethyl 1,6-diisocyanate (SC 100%) [Desmodur® N 3600, Bayer, Leverkusen], butyl acetate, and triethyl orthoformate. Under nitrogen blanketing, the dropping funnel is used for slow dropwise addition of a mixture of bis[3-trimethoxysilylpropyl]amine (Dynasylan® 1124, EVONIK, Rheinfelden) and N-[3-(trimethoxysilyl)propyl]butylamine (Dynasylan® 1189, EVONIK, Rheinfelden). The reaction is exothermic. The rate of addition is selected such that the internal temperature does not exceed a maximum of 60° C. Further butyl acetate is subsequently added via the dropping funnel. 60° C. is maintained for four hours more until the titrimetric determination of the isocyanate content (to DIN EN ISO 11909) gives a constant value. The amounts of the synthesis components used, and the characteristics of the curing agent, are reported in table 1.

TABLE 1
Composition of the curing agent solutions used in inventive
examples B1 to B9 and comparative example V1 in g

| | B1 | B2 | B3 | B4 | B5 | V1 | B6 | B7 | B8 | B9 |
|---|---|---|---|---|---|---|---|---|---|---|
| Desmodur ® N 3600 | — | — | — | — | — | — | 51.6 | 51.6 | 51.6 | 58.8 |
| Desmodur ® N 3300 | 45.9 | 38.4 | 44.9 | 36.9 | 43.9 | 35.6 | — | — | — | — |
| Butyl acetate | 33.0 | 27.6 | 32.3 | 26.6 | 31.6 | 25.6 | 20.0 | 20.0 | 20.0 | 10.0 |
| Triethyl | 2.0 | 2.1 | 2.0 | 2.1 | 2.0 | 2.2 | — | — | — | — |
| orthoformate | | | | | | | | | | |
| Bis[3- | 7.3 | 12.2 | 14.3 | 23.5 | 20.9 | 34.0 | 26.4 | 26.4 | 26.4 | 29.4 |
| trimethoxysilyl- | | | | | | | | | | |
| propyl]amine | | | | | | | | | | |
| N-[3-(Trimethoxysilyl)- | 11.8 | 19.7 | 6.6 | 10.8 | 1.6 | 2.6 | 2.0 | 2.0 | 2.0 | 1.8 |
| propyl]butylamine | | | | | | | | | | |
| Binder fraction | 65 | 70 | 66 | 71 | 66 | 72 | 80 | 80 | 80 | 90 |
| curing agent in | | | | | | | | | | |
| wt % | | | | | | | | | | |
| NCO content in wt % | 10.8 | 4.8 | 10.4 | 4.5 | 10 | 4.3 | 11.7 | 11.7 | 11.7 | 11.7 |
| Degree of | 30 | 60 | 30 | 60 | 30 | 60 | 30 | 30 | 30 | 29.2 |
| silanization in % | | | | | | | | | | |
| Amount of | 30 | 30 | 60 | 60 | 90 | 90 | 90 | 90 | 90 | 92 |
| bissilane in mol % | | | | | | | | | | |
| Amount of | 70 | 70 | 40 | 40 | 10 | 10 | 10 | 10 | 10 | 8 |
| monosilane in mol % | | | | | | | | | | |
| NCO groups reacted | 9 | 18 | 18 | 36 | 27 | 54 | 27 | 27 | 27 | 27 |
| with bissilane, in % | | | | | | | | | | |

Key to table 1:
Desmodur ® N 3600 = commercial trimerized isocyanurate based on hexamethyl 1,6-diisocyanate, FC 100%, Bayer, Leverkusen
Desmodur ® K 3300 = commercial trimerized isocyanurate based on hexamethyl 1,6-diisocyanate, FC 100%, Bayer, Leverkusen

### Formulation of the Coating Materials of Inventive Examples 1 to 9 and the Coating Material of Comparative Example V1, and Also of the Corresponding Coatings of Examples 1 to 9 and of Comparative Example V1

To produce the base varnishes (S1) to (S9) of the inventive examples and the base varnish (VS1) of the comparative example, the constituents indicated in table 2 are weighed out in the order stated (beginning from the top) into a suitable vessel, in that order, and are intimately stirred together with one another.

To produce the coating materials (K1) to (K9) of the inventive examples and the coating material (VK1) of the comparative example, the amounts of the base varnishes and of the curing agent solutions indicated in table 2 are weighed out in the order stated (beginning from the top) into a suitable vessel, in that order, and are intimately stirred together with one another.

TABLE 2
Composition of the base varnishes S1 to S9 of the inventive examples 1 to 9 and the base varnish
VS1 of the comparative example, and of the coating materials K1 to K9 and VK1, in parts by weight

| Example | 1 | 2 | 3 | 4 | 5 | V1 | 6 | 7 | B8 | B9 |
|---|---|---|---|---|---|---|---|---|---|---|
| Base varnish | S1 | S2 | S3 | S4 | S5 | VS1 | S6 | S7 | S8 | S9 |
| constituents | | | | | | | | | | |
| A1 | 53.1 | 53.1 | 53.1 | 53.1 | 53.1 | 53.1 | 26.7 | 26.7 | 27.3 | 30.0 |
| A2 | 0.0 | 0.0 | 0.0 | 0.0 | 0.0 | 0.0 | 12.7 | 12.7 | 9.3 | 10.0 |
| A3 | 0.0 | 0.0 | 0.0 | 0.0 | 0.0 | 0.0 | 13.6 | 13.6 | 0.0 | 0.0 |
| A4 | 0.0 | 0.0 | 0.0 | 0.0 | 0.0 | 0.0 | 0.0 | 0.0 | 0.0 | 18.0 |
| Rheology | 0.0 | 0.0 | 0.0 | 0.0 | 0.0 | 0.0 | 0.0 | 0.0 | 15.0 | 0.0 |
| agent ¹⁾ | | | | | | | | | | |
| Nacure ® | 2.2 | 2.2 | 2.2 | 2.2 | 2.2 | 2.2 | 3.2 | 3.2 | 2.3 | 0.0 |
| 4167 ²⁾ | | | | | | | | | | |
| K-Kat. 348 ³⁾ | 0.2 | 0.2 | 0.2 | 0.2 | 0.2 | 0.2 | 0.2 | 0.2 | 0.0 | 0.0 |
| D2EHPA ⁴⁾ | 1.0 | 1.0 | 1.0 | 1.0 | 1.0 | 1.0 | 1.0 | 1.0 | 1.0 | 0.5 |
| Benzoic | 0.0 | 0.0 | 0.0 | 0.0 | 0.0 | 0.0 | 0.0 | 0.0 | 0.0 | 1.5 |
| acid | | | | | | | | | | |
| DBTL ⁵⁾ | 0.0 | 0.0 | 0.0 | 0.0 | 0.0 | 0.0 | 0.0 | 0.0 | 0.0 | 1.5 |
| Tinuvin ® | 2.3 | 2.3 | 2.3 | 2.3 | 2.3 | 2.3 | 3.4 | 3.4 | 1.1 | 2.3 |
| 384 ⁶⁾ | | | | | | | | | | |
| Tinuvin ® | 1.0 | 1.0 | 1.0 | 1.0 | 1.0 | 1.0 | 1.0 | 1.0 | 1.0 | 1.0 |
| 292 ⁷⁾ | | | | | | | | | | |
| Surface- | 0.05 | 0.05 | 0.05 | 0.05 | 0.05 | 0.05 | 0.05 | 0.05 | 0.05 | 0.3 |
| active | | | | | | | | | | |
| agent ⁸⁾ | | | | | | | | | | |
| Leveling | 0.03 | 0.03 | 0.03 | 0.03 | 0.03 | 0.03 | 0.03 | 0.03 | 0.03 | 1.0 |
| agent ⁹⁾ | | | | | | | | | | |
| Solvent- | 18.5 | 18.5 | 18.5 | 18.5 | 18.5 | 18.5 | 18.1 | 18.1 | 20.3 | 0 |
| naphtha ® | | | | | | | | | | |
| Butyl | 21.62 | 21.62 | 21.62 | 21.62 | 21.62 | 21.62 | 20.02 | 20.02 | 22.62 | 9.9 |
| acetate | | | | | | | | | | |
| Methyl | 0.0 | 0.0 | 0.0 | 0.0 | 0.0 | 0.0 | 0.0 | 0.0 | 0.0 | 24.0 |
| isobutyl | | | | | | | | | | |
| ketone | | | | | | | | | | |
| Total base | 100.0 | 100.0 | 100.0 | 100.0 | 100.0 | 100.0 | 100.0 | 100.0 | 100.0 | 100.0 |
| varnish in | | | | | | | | | | |
| parts by wt. | | | | | | | | | | |
| Curing agent in | | | | | | | | | | |
| parts by wt. | | | | | | | | | | |
| B1 | 64.5 | | | | | | | | | |
| B2 | | 136.6 | | | | | | | | |
| B3 | | | 67.8 | | | | | | | |
| B4 | | | | 146.8 | | | | | | |
| B5 | | | | | 69.1 | | | | | |
| V1 | | | | | | 160.3 | | | | |
| B6 | | | | | | | 48.9 | | | |
| B7 | | | | | | | | 48.9 | | |
| B8 | | | | | | | | | 50.0 | |
| B9 | | | | | | | | | | 50.0 |

Key to table 2:
¹⁾ Commercial rheology agent from Nuplex Resins, the Netherlands, based on urea, dissolved or dispersed in a polyester binder, with a nonvolatile fraction of 55 wt %
²⁾ Commercial catalyst from King Industries, based on amine-blocked bis(2-ethylhexyl) phosphate
³⁾ Commercial catalyst from King Industries, based on bismuth
⁴⁾ Commercial bis(2-ethylhexyl) phosphate from Lanxess
⁵⁾ DBTL = dibutyltin dilaurate
⁶⁾ Commercial light stabilizer from BASF SE, based on a UV absorber
⁷⁾ Commercial light stabilizer from BASF SE, based on HALS
⁸⁾ Commercial surface-active agent based on a polyether-modified polydimethylsiloxane
⁹⁾ Commercial leveling agent based on methylalkylpolysiloxane

### Production of the Coatings of Examples 1 to 9 and of Comparative Example V1

Bonder panels are coated in succession with a commercial electrocoat (CathoGuard® 500 from BASF Coatings GmbH, film thickness 20 μm) and baked in each case at 175° C. for 15 minutes. This is followed by coating with commercial white waterborne basecoat material (ColorBrite® from BASF Coatings GmbH), with flashing at ambient temperature for 15 minutes in each case. The coating materials of examples B1 to B6 and also B8 and B9 and of comparative example V1 are subsequently applied using a gravity-fed cup-type gun, and are baked together with the basecoat at 90° C. for 45 minutes. The film thickness of the clearcoat is 30 to 35 μm, that of the basecoat ˜15 μm.

Commercial aluminum panels made from pressure-cast alloy AC42100, and pretreated with Gardobond® R2601, and also coated with an epoxy/polyester powder coating and with a conventional one-component high-solids basecoat material, applied over the powder coating and baked, are coated with the coating material of example 7 and baked at 90° C. for 45 minutes. The film thickness of the clearcoat is 30 to 35 μm.

The scratch resistance of the surfaces of the resultant coatings was determined one week after their production, using the Crockmeter test (in accordance with EN ISO 105-X12 with 10 double rubs and 9N applied force, using 9 μm abrasive paper (3M 281Q Wetordry™ Production™), with subsequent determination of the residual gloss at 20° using a commercial gloss device). In addition, the scratch resistance was again determined after the panels had been stored at 60° C. for 60 minutes (reflow conditions) subsequent to the scratch exposure, this determination taking place by means of the aforementioned Crockmeter test. The results are set out in tables 3 and 4.

Also determined was the universal hardness (micropenetration hardness) to DIN EN ISO 14577-4 DE. The results are likewise set out in tables 3 and 4. Determinations were additionally made of the network density and of the glass transition temperature of the cured coatings of coating material compositions (K), using DMTA measurements on free films. The results are likewise set out in tables 3 and 4.

The brake dust resistance of the coatings here is determined by the method described above. These test results as well are reported in tables 3 and 4.

TABLE 3
Test results for the coatings of examples 1 to 5 and of comparative example V1

| | | | | | | Crockmeter | | | Network |
|---|---|---|---|---|---|---|---|---|---|
| | | | | | | 9 μm | Universal | | density |
| | | | | | | (reflow | hardness | Tg | [Pa] |
| Example | Cycle 1 | Cycle 2 | Cycle 3 | Cycle 4 | Notes | 60′ 60° C.) | [N/mm\hat{ }2] | [° C.] | *10\hat{ }7 |
| 1 | 1 | 2 | 3 | 3 | | 75% (96%) | 100 | 71 | 3.6 |
| 2 | 1 | 2 | 3 | 3 | | 83% (97%) | 109 | 80 | 5 |
| 3 | 1 | 2 | 3 | 3 | | 84% (98%) | 105 | 75 | 4.3 |
| 4 | 1 | 2 | 2 | 3 | | 89% (98%) | 112 | 82 | 6.8 |
| 5 | 1 | 1 | 2 | 3 | | 86% (98%) | 108 | 76 | 5.4 |
| V1 | 1 | 1 | 1 | 3 | Cracks | 92% (98%) | 112 | 84 | 9.1 |
| | | | | | from | | | | |
| | | | | | cycle 2 | | | | |
| | | | | | onward! | | | | |

TABLE 4
Test results for the coatings of examples 6 to 9:

| | | | | | Crockmeter | | | Network |
|---|---|---|---|---|---|---|---|---|
| | | | | | 9 μm | Universal | | density |
| | | | | | (reflow | hardness | Tg | [Pa] |
| Example | Cycle 1 | Cycle 2 | Cycle 3 | Cycle 4 | 60′ 60° C.) | [N/mm\hat{ }2] | [° C.] | *10⁷ |
| 6 | 1 | 1 | 1 | 2 | 86% (97%) | 112 | 80 | 4.7 |
| 7 | 1 | 1 | 1 | 2 | | | | |
| 8 | 1 | 1-2 | 2-3 | 3 | 75% (94%) | | 79 | 3.8 |
| 9 | 1 | 2 | 3 | 3 | 56% (95%) | | 69 | 3.2 |

### Discussion of the Test Results

The comparison of the coatings of inventive examples 1 to 3 with the inventive examples 4 to 5 in table 3 shows that the brake dust resistance of the coatings is significantly improved if the fraction in component (B) of the isocyanate groups originally present that have undergone reaction to give bissilane groups of formula (I) goes up. Specifically, in inventive examples 1 to 3, only 9% and 18 mol %, respectively, of the isocyanate groups originally present have undergone reaction to form bissilane groups (I), whereas in inventive examples 4 and 5 between 27 and 36 mol % of the isocyanate groups originally present have undergone reaction to form bissilane groups (I). Accordingly, starting from the third cycle of the brake dust resistance test, the coatings of examples B1 to B3 are no longer satisfactory (rating 3), whereas the inventive examples 4 and 5 all receive a rating of at least 2 in the third test cycle. However, the fraction of the original isocyanate groups reacted to give the bissilane structures (I) should not be too high, since in the case of a very high fraction, such as 54 mol % in comparative example V1, for example, the surfaces become more brittle and there are therefore cracks.

Furthermore, the comparison of examples 6 to 9 in table 4 shows that in addition, the catalyst combination selected also has an influence on the properties of the resulting coatings. Through the use of the inventively employed catalyst (D) based on the phosphorus-containing acids and/or the partial esters of phosphorus-containing acids, the coatings of the invention all have both a good brake-dust resistance in the first cycle (rating “1” in each case) and good scratch resistance in the Crockmeter test before reflow. Nevertheless, inventive example 9, in which the coating material contains only the catalyst (D), dibutyltin dilaurate as catalyst (Z), and benzoic acid as reaction accelerator (R), has not only a poorer scratch resistance before reflow but also a poorer brake-dust resistance (rating “2” in the second cycle and rating “3” in each of the third and fourth cycles) than inventive examples 6 to 8, all of which include not only the catalyst (D) but also the catalyst (N) based on the amine adduct of the phosphoric diester and receive, accordingly, better ratings in the second and third cycles of the brake dust test.

1: A method for producing a coating on a metal surface, the method comprising:
applying a coating material composition (K) to at least a part of the metal surface,
wherein the coating material composition (K) comprises:
a) a polyhydroxyl group-containing component (A),
b) a component (B) having on average at least one free and/or blocked isocyanate group and having on average at least one hydrolyzable silane group of formula (I):
—N(X—SiR″x(OR′)3-x)n(X′—SiR″y(OR′)3-y)m (I)
wherein
R′ is hydrogen, alkyl, cycloalkyl, aryl, or aralkyl, wherein a carbon chain thereof is optionally interrupted by nonadjacent oxygen, sulfur, or NRa groups, wherein Ra is alkyl, cycloalkyl, aryl, or aralkyl,
X and X′ are each linear and/or branched alkylene or cycloalkylene radical having 1 to 20 carbon atoms,
R″ is alkyl, cycloalkyl, aryl, or aralkyl, wherein a carbon chain thereof is optionally interrupted by nonadjacent oxygen, sulfur, or NRa groups, wherein Ra is alkyl, cycloalkyl, aryl or aralkyl,
n is a number of 0 to 2,
m is a number of 0 to 2,
m+n is a number of 2, and
x and y are each number of 0 to 2, and
c) a phosphorus-containing catalyst (D),
wherein the metal surface is optionally a metal surface of a wheel rim,
5 to 50 mol % of the isocyanate groups originally present in the component (B) undergoes a reaction to form silane groups of the formula (I), and
the phosphorus-containing catalyst (D) is at least one selected from the group consisting of a phosphorus-containing acid and a partial ester of a phosphorus-containing acid.

2: The method as claimed in claim 1, wherein 10 to 50 mol % of the isocyanate groups originally present in the component (B) undergoes the reaction to form the silane groups of the formula (I).

3: The method as claimed in claim 1, wherein the metal surface consists of aluminum or steel.

4: The method as claimed in claim 1, wherein the phosphorus-containing catalyst (D) is at least one selected from the group consisting of an optionally substituted acyclic phosphoric monoester, an optionally substituted cyclic phosphoric monoester, an optionally substituted acyclic phosphoric diester, and an optionally substituted cyclic phosphoric diester.

5: The method as claimed in claim 1, wherein the coating material composition (K) further comprises:
a catalyst (N), which is different from the phosphorus-containing catalyst (D) and is at least one selected from the group consisting of an amine adduct of an optionally substituted phosphonic diester, an amine adduct of an optionally substituted diphosphonic diester, an amine adduct of an optionally substituted phosphoric monoester and an amine adduct of an optionally substituted phosphoric diester.

6: The method as claimed in claim 1, wherein the coating material composition (K) additionally comprises:
a reaction accelerator (R), which is different from the phosphorus-containing catalyst (D) and which is at least one selected from the group consisting of a phosphorus-free acid and a partial ester of a phosphorus-free acid.

7: The method as claimed in claim 1, wherein the coating material composition (K) additionally comprises:
a catalyst (Z) for reacting hydroxyl groups with the isocyanate groups, which is at least one selected from the group consisting of a zinc carboxylate, a bismuth carboxylate, an aluminum chelate, a zirconium chelate, a titanium chelate, a boron chelate, and an inorganic, tin-containing catalyst.

8: The method as claimed in claim 1, wherein the component (B) has
on average at least one hydrolyzable silane group of the formula (I):
—N(X—SiR″x(OR′)3-x)n(X′—SiR″y(OR′)3-y)m (I)
and
on average at least one hydrolyzable silane group of formula (II):
—NR—(X—SiR″x(OR′)3-x) (II),
wherein
R is hydrogen, alkyl, cycloalkyl, aryl, or aralkyl, wherein a carbon chain thereof is optionally interrupted by nonadjacent oxygen, sulfur, or NRa groups, wherein Ra is alkyl, cycloalkyl, aryl or aralkyl.

9: The method as claimed in claim 8, wherein 10 to 90 mol % of the isocyanate groups originally present in the component (B) undergoes a reaction to form silane groups of the formulae (I) and (II), and/or
a total amount of bissilane structural units (I) is between 6 and 100 mol %, and a total amount of monosilane structural units (II) is between 94 and 0 mol %, based in each case on an entirety of the bissilane structural units (I) plus the monosilane structural units (II).

10: The method as claimed in claim 1, wherein the coating material composition (K) comprises, at least one selected from the group comprising:
as the phosphorus-containing catalyst (D), an acyclic phosphoric diester and/or a cyclic phosphoric diester,
as a catalyst (Z), a Bi(III) salt of a branched C3 to C24 fatty acid,
as a reaction accelerator (R), a monomeric aromatic carboxylic acid, and
as a phosphorus- and nitrogen-containing catalyst (N), an amine adduct of phosphoric monoester and/or an amine adduct of a phosphoric diester.

11: The method as claimed in claim 1, wherein the coating material composition (K) comprises
the phosphorus-containing catalyst (D) in a fraction of 0.1 to 5.0 wt %,
optionally a catalyst (Z) in a fraction of 0.005 to 1.0 wt %,
optionally a reaction accelerator (R) in a fraction of 0.1 to 5.0 wt %, and
optionally a catalyst (N) in a fraction of 0.1 to 15.0 wt %, based in each case on a binder content of the coating material composition (K)
wherein
the catalyst (Z) is for reacting hydroxyl groups with the isocyanate groups and is at least one selected from the group consisting of a zinc carboxylate, a bismuth carboxylate, an aluminum chelate, a zirconium chelate, a titanium chelate, a boron chelate, and an inorganic, tin-containing catalyst;
the reaction accelerator (R) is different from the phosphorus-containing catalyst (D) and is at least one selected from the group consisting of a phosphorus-free acid and a partial ester of a phosphorus-free acid; and
the catalyst (N) is different from the phosphorus-containing catalyst (D) and is at least one selected from the group consisting of an amine adduct of an optionally substituted phosphonic diester, an amine adduct of an optionally substituted diphosphonic diester, an amine adduct of an optionally substituted phosphoric monoester and an amine adduct of an optionally substituted phosphoric diester.

12: The method as claimed in claim 1, wherein the coating material composition (K) comprises:
a mixture of 0.05 to 6.0 wt % of at least one light stabilizer (LS1) based on sterically hindered amines, and 0.5 to 15.0 wt % of at least one light stabilizer (LS2) based on UV absorbers, based in each case on a binder content of the coating material composition (K).

13: The method as claimed in claim 1, wherein the polyhydroxyl-group-containing component (A) is at least one compound selected from the group consisting of a polymethacrylate resin, and a polyacrylate resin,
wherein the compound has an OH number of 60 to 300 mgKOH/g, and/or has a glass transition temperature of −60° C. to <+10° C., measured in each case by DSC measurement.

14: The method as claimed in claim 1, the method further comprising:
applying the coating material composition (K) and optionally a pretreatment, optionally a primer, a pigmented basecoat composition or a corrosion-inhibiting coating composition to the metal surface, and
curing the pigmented basecoat composition or the corrosion-inhibiting coating composition with the coating material composition (K) at a temperature of 20 to 200° C.,
or
applying the coating material composition (K) directly to an optionally pretreated metal surface and
curing thereof at a temperature of 20 to 200° C.

15: A coating, produced by the method as claimed in claim 1.

16: A multicoat coating, comprising: the coating as claimed in claim 15, as a topcoat.
